(19) United States
(12) Patent Application Publication
(10) Pub. No.: US 2022/0332081 A1
(43) Pub. Date: Oct. 20, 2022

(54) Optimized Engineering Structures with Auxetic Cells

(71) Applicant: Amrita Vishwa Vidyapeetham, Tamil Nadu (IN)

(72) Inventors: Balakrishnan Shankar, Kollam (IN); Hariprasad Mohan Prasanna, Balussery (IN); Shammo Dutta, Pashan (IN); Hrishikesh Gopakumar Menon, Navi (IN)

(73) Assignee: Amrita Vishwa Vidyapeetham, Tamil Nadu (IN)

(21) Appl. No.: 17/404,467

(22) Filed: Aug. 17, 2021

(30) Foreign Application Priority Data
Apr. 16, 2021 (IN) 202141017595

(51) Int. Cl. B32B 3/12; B32B 15/04; B32B 27/06; B32B 27/32; B32B 27/28

(52) U.S. Cl. CPC B32B 3/12; B32B 15/04; B32B 27/06; B32B 27/32; B32B 27/28

(57) ABSTRACT

The invention in its various embodiments discloses a structural member designed for improved load bearing using auxetic expandable-collapsible structural units. The auxetic structural units may have parallel-sided surfaces oriented at an angle (α) to the horizontal direction. In some embodiments the angle varies between 40-140 degree within a layer. The structural member may include at least two layers having identical structural units, the layers varying in orientation α of the structural units, or material or wall thickness thereof. In various embodiments, the angular orientation α may be the same in alternate layers. The structural member provides load bearing capacity of a solid component at 30-40% of material weight. The invention discloses an optimized structure with structural units oriented alternately at α values of 45° or 135° .

### CROSS-REFERENCES TO RELATED APPLICATIONS

The instant invention claims priority to Indian Patent Application 202141017595 filed 16 Apr. 2021. All disclosure of the parent application is incorporated at least by reference.

### BACKGROUND OF THE INVENTION

### 1. Field of the Invention

The present invention is in the technical area of engineering structures and relates in particular to design structural units for sustainable load bearing support.

### 2. Description of Related Art

A majority of the structures that people deal with in their day to day lives are seen to obey the conventional relation that is the lateral compression under a tensile load and vice versa. On the contrary, structures with negative Poisson's ratio are termed as auxetics. With advancements in topology of structural aspects, researchers have managed to fabricate/modify the geometries of certain structures incorporating negative or zero Poisson's ratio, which has several engineering advantages.

Advancements in manufacturing technologies and optimized auxetic structures are being pursued in view of the engineering advantages. Presence of negative Poisson's ratio behavior in nature has provided the lead to mankind in designing these kinds of structures artificially. Since auxetic structures possess negative Poisson's ratio, they can be exploited in many engineering applications. One such advantage is that of high local indentation resistance to an externally applied force. Some of the landmark improvements in such structures to their conventional counterparts are with respect to that of thermal/shock resistance, fracture toughness and shear modulus. A large range of auxetic foams and textiles used in sports attires are already brought into use. Auxetics obtain their peculiarities from their constituent geometry. One such geometrical variation of the conventional honeycomb is referred as re-entrant honeycomb, which is auxetic in nature. Studies have shown that the behaviors of such structures are the result of interplay of their material microstructure and their geometrical macrostructure.

U.S. Pat. Nos. 6,784,480B1, 8,652,602B1 disclose several approaches to achieving improved deformation properties using cell wall materials of planar auxetic structures formed into 3D auxetic structures which permit bending deformation. US application US20110029063A1 describes the geometry, dimensions to achieve variation in material properties along different directions to achieve a varying effective Young's modulus with different effective Poisson's ratios. Tran et al (2020) “Dynamic Analysis of Sandwich Auxetic Honeycomb Plates Subjected to Moving Oscillator Load on Elastic Foundation” analyzes the dynamic response and the superiority of sandwich composite plate with negative Poisson's in auxetic honeycomb core layer under moving oscillator load. Roberto Naboni and Lorenzo Mirante (2016) “Computational Design and Simulation of Bending-Active Auxetic Structures” describes the dynamic behavior of bending active 2D re-entrant structure with a computational design methodology to simulate the form-finding of synclastic auxetic grid shells. Th instant invention proposes a novel structural member to address some of the requirements discussed here.

### BRIEF SUMMARY OF THE INVENTION

An optimized structural member made of auxetic unit cells, designed to take on a bending load, the member made of identical repeating auxetic expandable-collapsible structural units. The member may comprise at least two layers extending in a horizontal plane and stacked vertically. Each layer may be filled completely with a plurality of structural units having a wall with thickness t, each structural unit having two parallel sided surfaces and two sides with reentrant surfaces. The reentrant surfaces are of equal dimension and oriented at an angle 90-θ with reference to the parallel sides, and the repeating structural units extend in the horizontal plane as required. the parallel sided surfaces are oriented at an angle α to the horizontal plane. In some embodiments, the structural units are made of a metal selected from aluminium, iron, copper, magnesium, or alloys thereof, a polymer selected from ABS, polypropylene, HDPE, polystyrene, or a combination thereof. In some embodiments, θ may vary in the range 20-30°. In one embodiment θ is 25°.

In various embodiments the structural member uses 30-40% by weight of a solid component for withstanding an equivalent load. In some embodiments, α varies between 45° to 135°. In one embodiment the repeating structural units in each layer are oriented alternately at an α value of 45° or 135°.

In some embodiments each layer of the comprises repeating structural units of identical wall thickness t. In some embodiments wall thickness in alternate layers is identical. In some embodiments the structural units are filled with a light weight filler material that resists compression. The filler material may comprise a material selected from solid or hollow spheres of metal or polymer. The structural member in some embodiments may comprise 3, 5 or 7 layers.

### BRIEF DESCRIPTION OF THE SEVERAL VIEWS OF THE DRAWINGS

FIG. 1A illustrates a structural member made of identical repeating auxetic expandable-collapsible structural units according to embodiments of the invention.

FIG. 1B shows expandable-collapsible structural units according to embodiments of the invention.

FIG. 2A illustrates a structural member with two layers of auxetic structures, the layers having α1=45°, α2=135°.

FIG. 2B shows orientation of auxetic clusters having α1=45° , and FIG. 2C shows orientation of auxetic clusters having α2=135° in FIG. 2A.

FIGS. 3A to 3L show various combinations of angular orientations αof 2-layered members.

FIGS. 4A and FIG. 4B illustrate evolution of the auxetic cell from the hexagonal cell.

FIG. 5A shows 4-point bend configuration used for testing. FIG. 5B shows the deflection characteristics of auxetic structures tested using the 4-point bend configuration.

FIG. 6 represents bar graph showing maximum deflection characteristics of 2-layer auxetic structures with various combinations of orientation angles α.

FIG. 7 represents the material consumption graph of auxetic clusters in comparison to that in a dimensionally similar homogeneous structure, honeycomb and the structural member.

### DETAILED DESCRIPTION OF THE INVENTION

While the invention has been disclosed with reference to certain embodiments, it will be understood by those skilled in the art that various changes may be made, and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate like parts throughout the views. Additionally, a reference to the singular includes a reference to the plural unless otherwise stated or inconsistent with the disclosure herein.

The invention in its various embodiments discloses a structural member designed for improved load bearing using auxetic expandable-collapsible structural units. The auxetic structural units may have parallel-sided surfaces oriented at an angle (a) to the horizontal direction. The structural member may include at least two layers having identical structural units, the layers varying only in orientation α of the structural units. In various embodiments, the angular orientation α may be the same in alternate layers. The structural member provides load bearing capacity of a solid component at 30-40% of material weight.

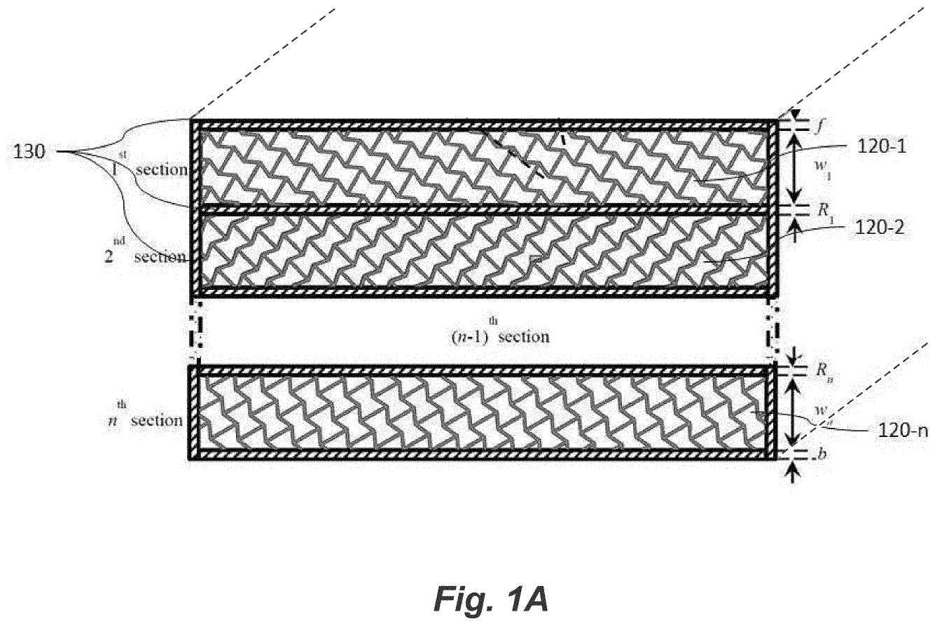

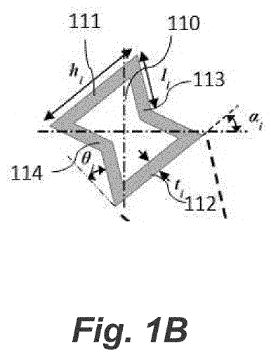

In various embodiments, the invention discloses a structural member 100 designed to take on a bending load, as disclosed with reference to FIG. 1A and FIG. 1B. The member may comprise at least two layers (120-1,120-2 . . . 120-n) extending in a horizontal plane, the layers being stacked vertically one upon the other. Each layer is filled completely with a plurality of auxetic expandable-collapsible structural units (110), as illustrated in FIG. 1B. The layers may be bounded by a membrane 130 on all sides. The membrane 130 may have thickness identical to that of the structural units 110.

In various embodiments each structural unit 110 is characterized by a number of parameters such as cell angle (θ), rib thickness (t), slant rib length (l) and horizontal rib length (h) as shown in FIG. 1B. Each repeating structural unit 110 consists of two parallel sided surfaces 111,112 and two sides with reentrant surfaces 113,114. The reentrant surfaces are of equal dimension, i.e. for a given cell, slant rib length l is the same on both reentrant surfaces. Thus, the slanted sides may be oriented at an angle 90-θ with reference to the parallel sides. In various embodiments the repeating structural units may extend in a depth direction as per requirement. In various embodiments, the parallel-sided surfaces may be oriented between 40-140 degree (α) to the horizontal direction.

In some embodiments the structural units 110 have two sides with reentrant surfaces wherein the reentrant surfaces are oriented at an angle θ varying in the range 20-30°. In some embodiments the structural members are oriented at an angle θ of 25°. In some embodiments the structural member 100 may have structural units 110 of thickness t such that the member may include only 30-40% by weight of material usage compared to a solid component for withstanding an equivalent load.

In some embodiments of the invention, the structural member 100 may include layers having identical structural units 110, the layers varying only in orientation of the structural units α. In alternative embodiments, the structural units 110 may have varying thickness or material composition, size or geometry, or a combination thereof in the different layers, while the units within a layer are identical. In various embodiments, the angular orientation α may be the same in alternate layers.

In various embodiments the structural member 100 is made of a metal selected from aluminium, iron, copper, magnesium, or alloys thereof. In some embodiments, the material of the member 100 may be a polymer selected from ABS, polypropylene, HDPE, polystyrene, or other structural polymer known in the art. In some embodiments, the structural member may include a combination of metals, alloys or polymers.

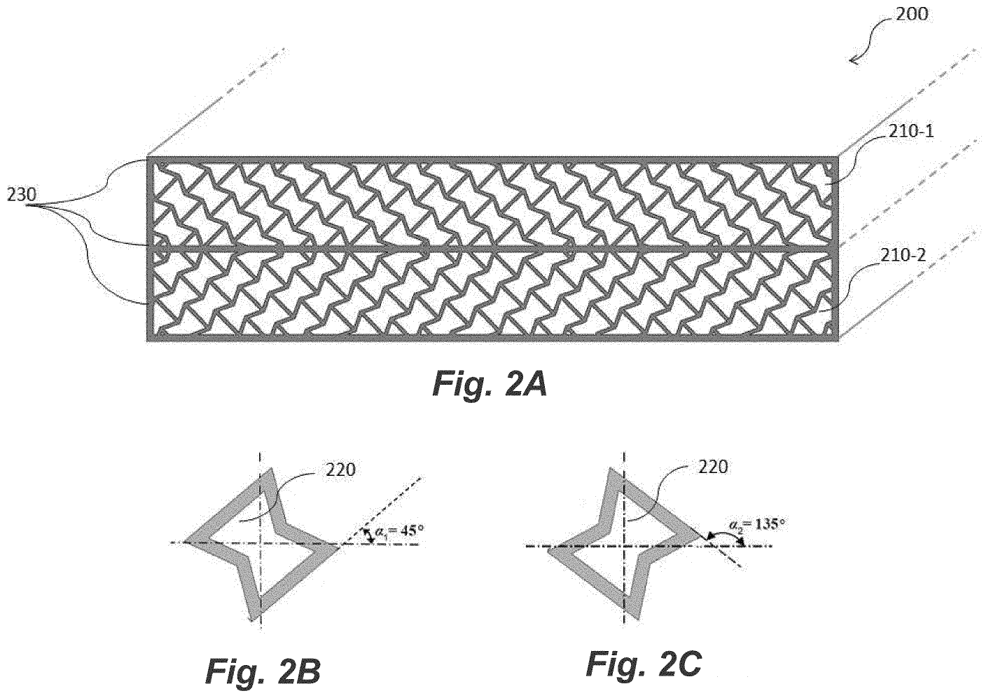

In one embodiment the invention discloses a structural member 200, as disclosed with reference to FIGS. 2A, 2B and 2C. In various embodiments the structural member includes 2 layers 220-1 and 220-2 as shown in FIG. 2A. The layer 220-1 is configured to have an α value of 45°, while the layer 220-2 may have α value of 135°, as shown in FIGS. 2B and 2C. The combination of layers with opposing angular alignment is configured to provide high resistance to bending loads. In various embodiments, the auxetic structural units 110 may either be hollow or may be filled with a lightweight filler material that is configured to provide resistance to compression. Filling the structural units with the filler material is configured to increase rigidity of the structure. Examples of such filler materials may be hollow or solid spheres of metal, or polymer.

In some embodiments the repeating structural unit in the structural member may have identical wall thickness in alternate layers. In some embodiments the structural member includes an odd number of layers such as 3, 5 or 7 layers. In various embodiments the structural membrane exhibits least deflection for ARS45-135. In some embodiments the structural member provides material usage for ARS45-135 of only 30-40% compared to a solid component for withstanding an equivalent load.

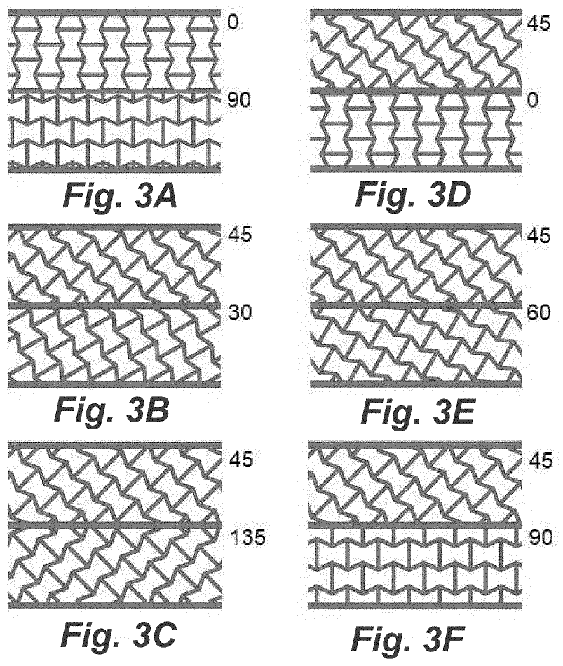

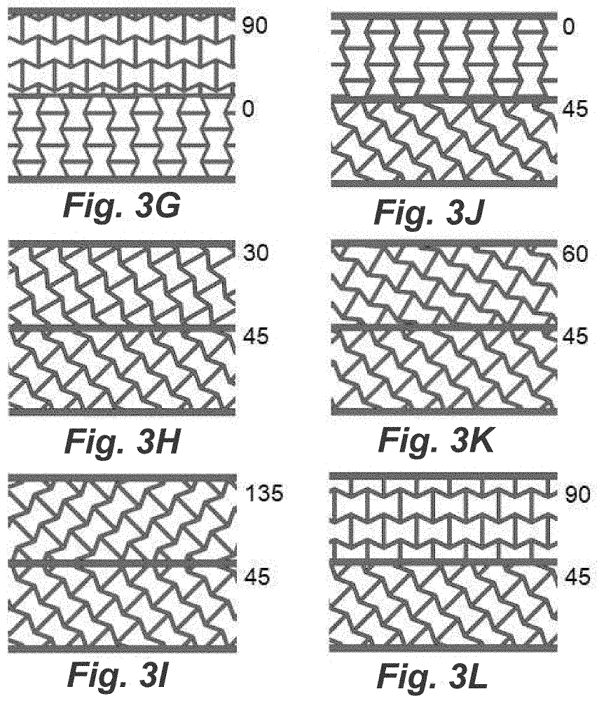

In various embodiments the structural member may have auxetic clusters with a value between 0° to 135° (0°-90°, 45°-90°, 45°-30°, 45°-60°, 45°-135° and 45°-0°) as shown in FIG. 3A to 3L.

While the above is a complete description of the embodiments of the invention, various alternatives, modifications, and equivalents may be used. It will be understood by those skilled in the art that various changes may be made, and equivalents may be substituted without departing from the scope of the invention as described above. In addition, many modifications may be made to adapt to a particular situation or material in the teachings of the invention without departing from its scope. Therefore, the above description and the examples to follow should not be taken as limiting the scope of the invention which is defined by the appended claims.

### EXAMPLES

### Example 1: Optimization of Reentrant Honeycomb—Rib Thickness and Cell Angle

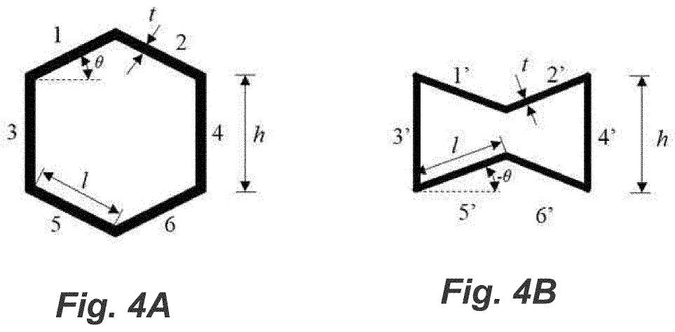

The conventional honeycomb has 6 sides as numbered in the honeycomb as shown in FIG. 4A. The parameters cell angle, rib thickness, slant rib length and horizontal rib length are represented by θ, t, l, h as shown in FIG. 4A. A re-entrant honeycomb is created when the 2 pairs of opposite ribs in the honeycomb are bent inwards, as illustrated in FIG. 4B.

The honeycomb, by itself is not auxetic in nature but the geometric maneuver of forming reentrant sides lends it the auxetic property. The modeling of the same was carried out in ABAQUS and tested under application of tensile pressure on rib 3′. The expression for assessing Poisson's ratio of honeycomb is given by equation 1.

$$v = \frac{( h / l + sin θ ) sin θ}{{cos}^{2} θ} \qquad ( 1 )$$

Observing the geometry of the auxetic unit cell, we can see that under loading, rib 3′ is under bending and the non-parallel ribs 1,2,5,6 experience shear. In such a situation, the conventional Poisson's ratio formula (1) used for honeycomb does not provide accurate results. In addition to that, the derivation of analytical formula is made on the basis of assuming that the value of relative density (t/l) to be negligible, which may not be correct in a real case. Thus, numerical or experimental methods need to be adopted to calculate the Poisson's ratio accurately where that ratio is not small.

The method adopted in this work is to take the ratio of strains (εₓₓ and ε_{yy}) in the lateral and the longitudinal direction. To do so, four points located centrally along the rib were chosen to ensure no errors arise due to stress concentration at the tips. Nodal displacements along the Y direction (for points 1 and 2) as well as the X directions (for points 3 and 4) are calculated with the help of the formulae stated. Dimensions L₁₂ (for the Y direction) and L₃₄ (for the X direction) are calculated from the un-deformed cell. These values are plugged into equations as shown below to get the strain values as finally the Poisson's ratio. The formulated equation is (2).

$${Δ}_{x} = {( {δ}_{x} )}_{3} - {( {δ}_{x} )}_{4} \\ {Δ}_{y} = {( {δ}_{y} )}_{2} - {( {δ}_{y} )}_{1} \\ {ε}_{xx} = \frac{{Δ}_{x}}{{L}_{34}} \\ {ε}_{y y} = \frac{{Δ}_{y}}{{L}_{12}} \\ {v}_{y x} = - \frac{{ε}_{xx}}{{ε}_{y y}} \qquad ( 2 )$$

Owing to the limitations of the analytical formulation to incorporate the variation in rib thicknesses, one needs to depend on FEM or experimental methods to assess the dependence. The methodology that one comes up with for estimating the Poisson's ratio has to be cross verified with the theoretical formulae. Hence to do this, the required model structure has to be tailored according to the conditions put forward by the theoretical model. The structure was modelled adhering to all the conditions and then the Poisson's ratio was estimated with the proposed methodology as mentioned earlier. The validation process is carried out by modelling the re-entrant structure with various cell angles and then comparing the values of Poisson's ratio obtained numerically and theoretically. Table provides data of the same. One can see that the values are in agreement and the error percentages are minimal. Following the validation, a parametric study is carried out to explore the possibilities of the proposed methodology. The Poisson's ratio at various cell angles and h/l ratios are calculated and the data is as provided in Tables 1 and 2. The individual error percentages calculated here are also minimal. This hints towards the fact that this FEM methodology can be used for all the 2D designs of re-entrant honeycomb.

TABLE 1
Poisson's Ratio Calculated by FEM vs. Theoretical for h/l = 1.697

| Cell Angle (θ) | ν_{theoretical} | ν_{FEM} | Error (%) |
|---|---|---|---|
| −20° | −0.5216 | −0.5194 | 0.42 |
| −25° | −0.6561 | −0.6324 | 3.61 |
| −30° | −0.7985 | −0.7555 | 5.38 |
| −35° | −0.9610 | −0.9065 | 5.67 |

TABLE 2
Poisson's Ratio Calculated by FEM vs.
Theoretical for h/l = 2 and 2.5

| | h/l = 2 | | | h/l = 2.5 | | |
|---|---|---|---|---|---|---|
| θ | v_{theoretical} | v_{FEM} | Error(%) | v_{theoretical} | v_{FEM} | Error(%) |
| 20 | −0.6422 | −0.6189 | 3.63 | −0.8350 | −0.7849 | 6.00 |
| 25 | −0.8115 | −0.7665 | 5.54 | −1.0688 | −1 | 6.43 |
| 30 | −1 | −0.9394 | 6.06 | −1.3333 | −1.2372 | 7.20 |
| 35 | −1.2193 | −1.1366 | 6.78 | −1.6466 | −1.5147 | 8.01 |

### Example 2: Bending Deflection Analysis

The study was further taken forward to investigate the beams made of such structures. The structures were arranged as rectangular load-bearing frames of specified dimensions with outer frame span of 408 mm and width of 108 mm and the membrane having 4 mm rib thickness. The structure had two layers, with a membrane thickness of 2 mm between the layers. The structure was modelled and tested against 4-point bending. Two concentrated loads of 1000N each were applied at a distance of 136 mm from either extreme of the beam span on the top fiber. The beams were designated as Oriented Re-entrant Structure (ORS) (single layer), or Assorted combinations of Re-entrant Structures (ARS) as disclosed with reference to FIG. 3A to 3L. The orientation angles α₁ and α₂ of the structural units in each layer are shown in Table 3.

TABLE 3
Orientation Angles of Auxetic Structural
Units in the Top and Bottom Layers

| S. No | Top Layer, α₁ | Bottom Layer, α₂ | Nomenclature |
|---|---|---|---|
| 1 | 0° | 90° | ARS0-90 |
| 2 | 45° | 0° | ARS45-0 |
| 3 | 45° | 30° | ARS45-30 |
| 4 | 45° | 60° | ARS45-60 |
| 5 | 45° | 135° | ARS45-135 |
| 6 | 45° | 90° | ARS45-90 |
| 7 | 90° | 0° | ARS90-0 |
| 8 | 0° | 45° | ARS0-45 |
| 9 | 30° | 45° | ARS30-45 |
| 10 | 60° | 45° | ARS60-45 |
| 11 | 135° | 45° | ARS135-45 |
| 12 | 90° | 45° | ARS90-45 |

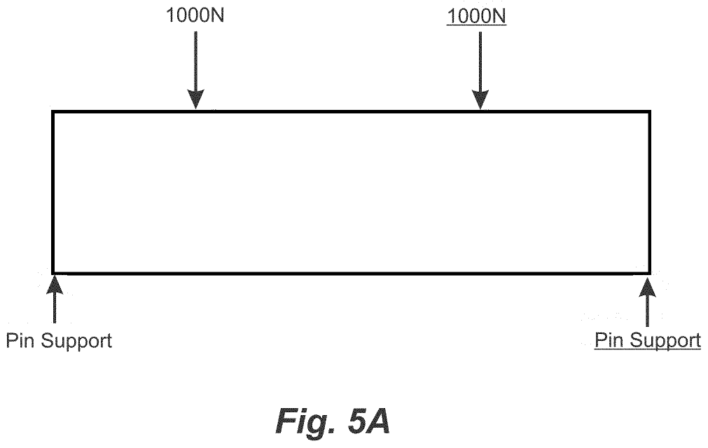

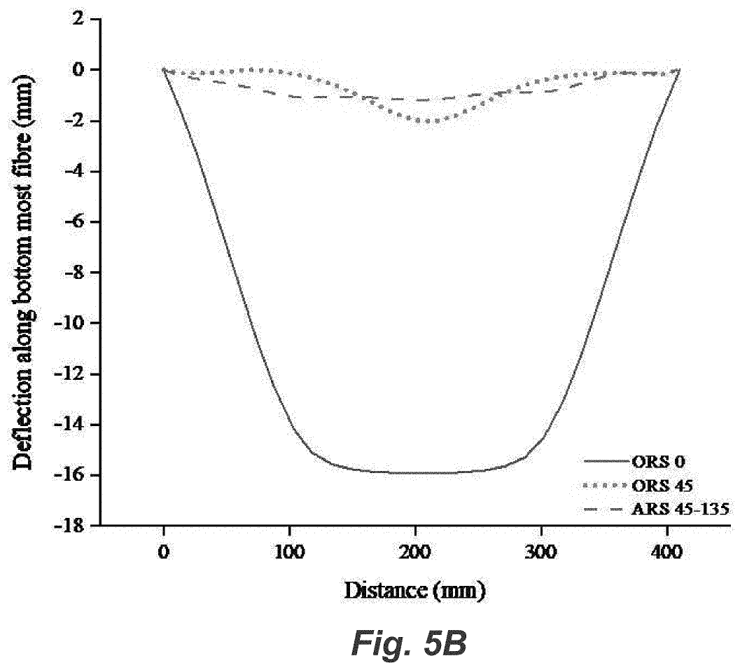

The beam designs were analyzed to demonstrate the improvement in mechanical properties by optimization of orientation. A single layer ORS45 and double layer ARS45-135 were analyzed using FEM and their deflection characteristics along the beam length were plotted against that of ORSO as shown in FIG. 5. The graph illustrates the uniform deflection characteristics and smaller maximum deflection of the 2-layer structure compared to the single layer one for the same load. The material used here was aluminium with a Young's modulus of 68 GPa and a material Poisson's ratio of 0.36.

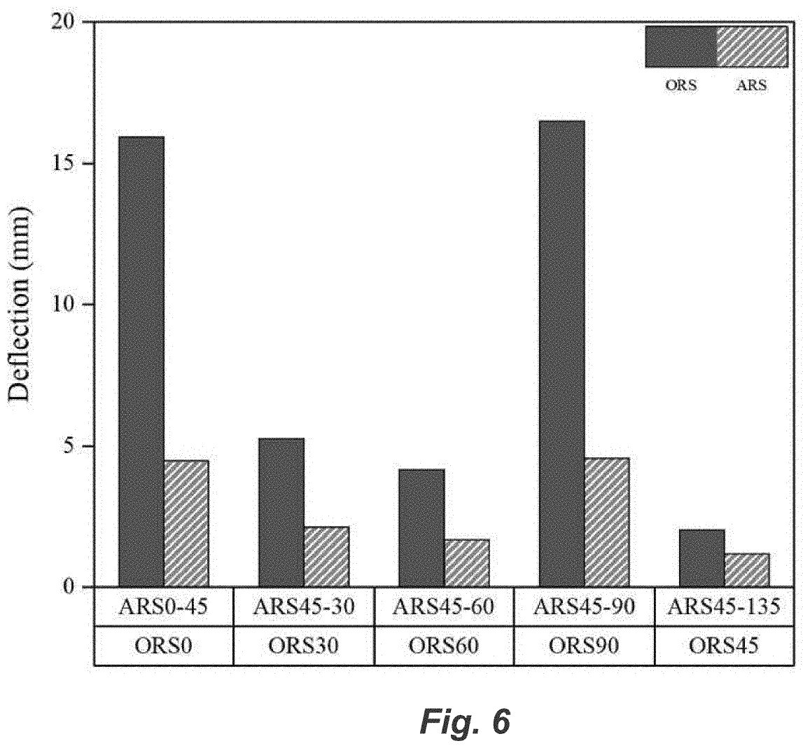

The analysis of other combinations of ARS beams with ARS4530, ARS4560, ARS4590, were compared with that of ARS45135 as shown in FIG. 6. The maximum deflection was least, about 1.186 mm, for ARS45135 configuration, while the ARS4560 and ARS4530 showed higher values of deflection than the optimum configuration.

### Example 3: Mass Fraction Analysis

The mass fraction of reduction in the usage of material is given as: mass fraction reduction=(mass of homogeneous beam−mass of auxetic beam)/mass of homogeneous beam.

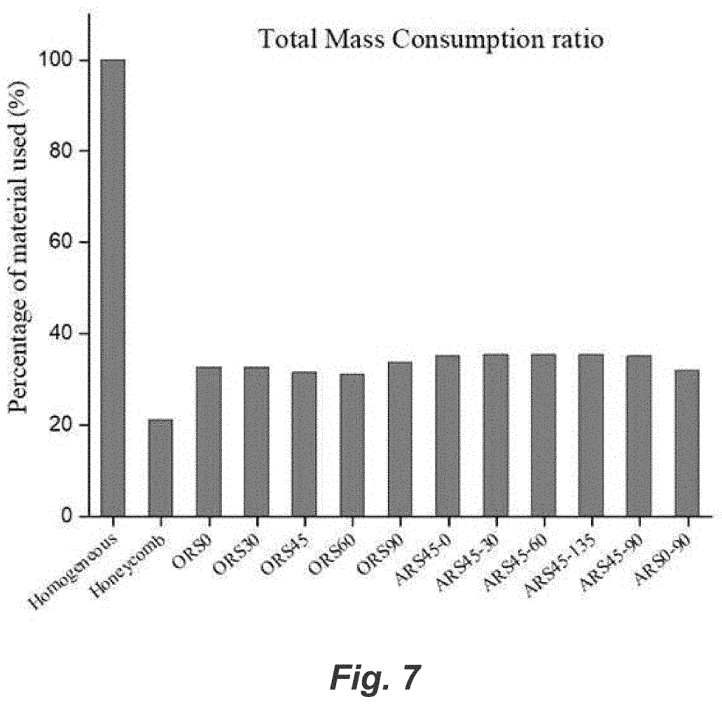

Mass of the equivalent homogeneous beam was calculated keeping the overall dimensions same as that of the auxetic designs; for aluminium as material was 0.119 kg. Mass of auxetic design (ARS45-135) was 0.042 kg. Mass fraction reduction for the auxetic design (ARS45-135)=0.64705=64.705%. In a similar way, the mass fraction of few auxetic designs shown in the below table were also calculated as given in FIG. 7.

1. A structural member adapted to resist a bending load, the structural member made of identical repeating auxetic expandable-collapsible structural units, the structural member comprising:
a first layer extending in a plane, comprising a plurality of auxetic structural units within the first layer, each auxetic structural unit having walls with thickness t, two opposite parallel sides and two opposite sides with reentrant surfaces, the first layer bounded by a membrane on all sides; and
a second layer separate from the first layer, extending in the plane of the first layer and stacked on the first layer, the second layer comprising a plurality of auxetic structural units within the second layer, each auxetic structural unit having walls with thickness t, two opposite parallel sides and two opposite sides with reentrant surfaces, the second also layer bounded by a membrane on all sides;
wherein the reentrant surfaces of the opposite sides of each auxetic structural unit are of equal dimension and are oriented at an angle 90-θ with reference to the parallel sides, and wherein the parallel sided surfaces of each auxetic structural unit are oriented at an angle α to the plane.

2. The structural member as claimed in claim 1, wherein the auxetic structural units are made of a metal selected from aluminium, iron, copper, magnesium, or alloys thereof, a polymer selected from Acrylonitrile Butadiene Styrene (ABS), polypropylene, High Density Polyethylene (HDPE), polystyrene, or a combination thereof.

3. The structural member as claimed in claim 1, wherein for the auxetic structural units the angle θ varies in a range of 20-30°.

4. The structural member as claimed in claim 1, wherein for the auxetic structural units the angle θ is 25°.

5. (canceled)

6. The structural member as claimed in claim 1, wherein the angle α for each layer varies between 45° and 135°.

7. The structural member as claimed in claim 1, wherein the plurality of auxetic structural units in each layer are oriented alternately at an α value of 45° or 135°.

8. The structural member as claimed in claim 1, wherein each layer comprises repeating auxetic structural units of identical wall thickness.

9. The structural member as claimed in claim 8, wherein wall thickness of the auxetic structural units in alternate layers is identical.

10. The structural member as claimed in claim 1, wherein the plurality of auxetic structural units are filled with a lightweight filler material that resists compression.

11. The structural member as claimed in claim 10, wherein the lightweight filler material comprises a material selected from solid or hollow spheres of metal or polymer.

12. The structural member as claimed in claim 1, comprising 3, 5 or 7 layers.

13. The structural member as claimed in claim 1, wherein α is the same for all layers.

14. The structural member as claimed in claim 1, wherein α differs for each layer.
